(19) United States
(12) Patent Application Publication
(10) Pub. No.: US 2010/0306807 A1
(43) Pub. Date: Dec. 2, 2010

(54) Content Reproduction Apparatus and Content Reproduction Method

(76) Inventors: Takashi Narahara, Ome-shi (JP); Yasuhiro Fujiyoshi, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/708,440

(22) Filed: Feb. 18, 2010

(30) Foreign Application Priority Data
May 29, 2009 (JP) 2009-131131

(51) Int. Cl. H04N 5/93

(52) U.S. Cl. 725/87; 386/E05.028

(57) ABSTRACT

According to one embodiment, a content reproduction apparatus comprises a receiving module that receives, from a server via a network, a channel including a plurality of contents arranged along a time base so as to be distributable, a reproduction module that selectively reproduces the contents included in the received channel, and a control module that shows, when reproduction of a final content on the time base in the channel is completed, that reproduction of the final content is completed, wherein the reproduction module further reproduces, after it is shown that reproduction of the final content is completed, another content included in the channel.

### CROSS-REFERENCE TO RELATED APPLICATIONS

This application is based upon and claims the benefit of priority from Japanese Patent Application No. 2009-131131, filed May 29, 2009, the entire contents of which are incorporated herein by reference.

### BACKGROUND

1. Field

One embodiment of the present invention relates to improvements of content reproduction apparatuses and content reproduction methods that access a server connected over a network, such as the Internet, and acquires and reproduce contents, such as pictures and sounds.

2. Description of the Related Art

As is well known, shifting to digital broadcasting has recently been promoted in television broadcasting. For example, in Japan, not only satellite digital broadcasting, such as broadcasting satellite (BS) digital broadcasting and 110-degree communication satellite (CS) digital broadcasting, but also digital terrestrial broadcasting has been started.

At present, Internet broadcasting that distributes contents, such as pictures and sounds, through a network typified by the Internet and the like is put into practical use. In particular, a video distribution service, referred to as a so-called video on demand (VOD), in which a server connected over a network distributes a content immediately in response to a user's request, is widely spreading.

Therefore, a digital broadcast receiving device that receives the digital television broadcasting mentioned above tends to have a function that supports a VOD service, that is, a function of accessing a given server through a network to request a desired content and receiving the content transmitted from the server to reproduce the content.

However, such a VOD service is still in an immature state of development, and in the future is likely to be improved to be in various forms in order to make the service more convenient for users to handle. To address this development, the above-mentioned digital broadcast receiving device supporting the VOD service needs to be effectively adaptable to newly developed service contents.

Jpn. Pat. Appln. KOKAI Publication No. 2004-159367 discloses a program guide system that simultaneously displays a television program selected by a viewer and a program guide display, allowing the viewer to use the program guide display to browse available VOD while continuing to view the selected television program in the background of the program guide display.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1, which shows an embodiment of this invention, is a view showing an example of a digital television broadcast receiving device and a network system mainly including the device for the sake of explanation;

FIG. 2 is a block diagram showing a main signal processing system of the digital television broadcast receiving device in the embodiment for the sake of explanation;

FIG. 3 is an external view showing a remote controller of the digital television broadcast receiving device in the embodiment for the sake of explanation;

FIGS. 4A to 4C are views showing various mode screens displayed on the digital television broadcast receiving device in the embodiment for the sake of explanation;

FIGS. 5A to 5C are views showing switching of a content on a full-screen reproduction mode screen displayed on the digital television broadcast receiving device in the embodiment for the sake of explanation;

FIGS. 6A to 6C are views showing a first service configuration that the digital television broadcast receiving device in the embodiment performs, for the sake of explanation;

FIG. 7 is a flow chart showing processing operation of the first service configuration that the digital television broadcast receiving device in the embodiment performs, for the sake of explanation;

FIGS. 8A to 8E are views showing a second service configuration that the digital television broadcast receiving device in the embodiment performs, for the sake of explanation; and

FIG. 9 is a flow chart showing processing operation of the second service configuration that the digital television broadcast receiving device in the embodiment performs, for the sake of explanation.

### DETAILED DESCRIPTION

Various embodiments according to the invention will be described hereinafter with reference to the accompanying drawings. In general, according to one embodiment of the invention, a content reproduction apparatus comprises a receiving module that receives, from a server via a network, a channel including a plurality of contents arranged along a time base so as to be distributable, a reproduction module that selectively reproduces the contents included in the received channel, and a control module that shows, when reproduction of a final content on the time base in the channel is completed, that reproduction of the final content is completed, wherein the reproduction module further reproduces, after it is shown that reproduction of the final content is completed, another content included in the channel.

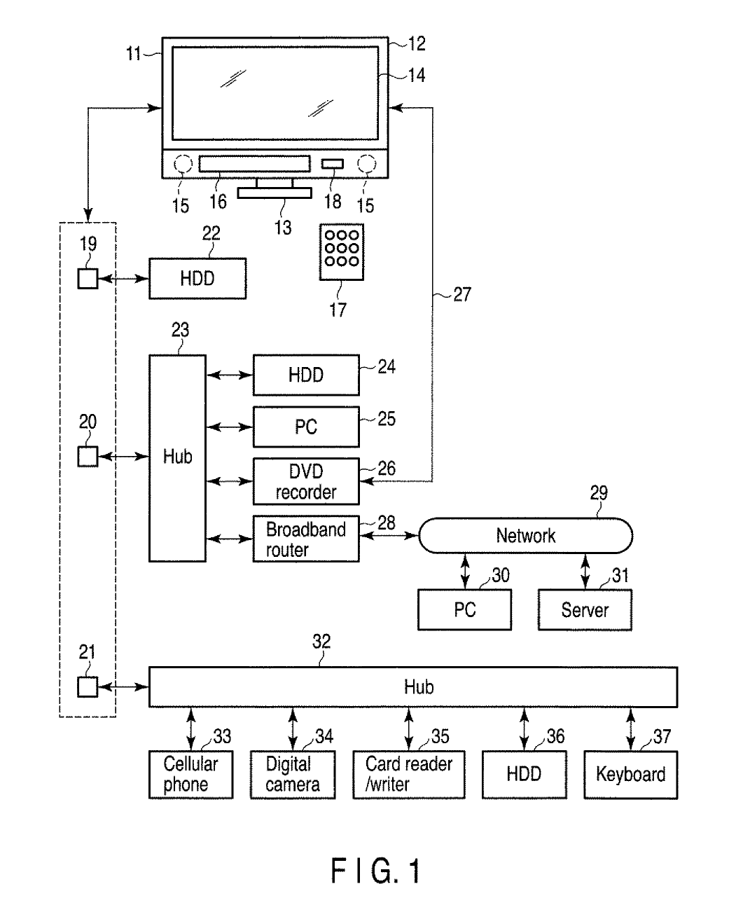

FIG. 1 schematically shows an example of an appearance of a digital television broadcast receiving device 11 to be described in this embodiment and a network system mainly including the digital television broadcast receiving device 11.

That is, the digital television broadcast receiving device 11 mainly comprises a thin-type cabinet 12 and a support table 13 that supports the cabinet 12 in an upright state. In the cabinet 12, an image display 14, which is, for example, a flat-panel-type display provided with a liquid crystal display panel and so on, a pair of loudspeakers 15, 15, an operation module 16, a light receiver 18 that receives operation information transmitted from a remote controller 17, and the like are disposed.

The digital television broadcast receiving device 11 also includes a first local area network (LAN) terminal 19, a second LAN terminal 20 and a universal serial bus (USB) terminal 21.

Among them, the first LAN terminal 19 is used as a dedicated port for a LAN-compatible hard disk drive (HDD), and is used for recording and reproducing information on a LAN-compatible HDD 22, which is a network attached storage (NAS) connected to the first LAN terminal 19, by means of the Ethernet (registered trademark).

In this way, providing the first LAN terminal 19 as a dedicated port for a LAN-compatible HOD makes it possible to stably record information of a program in a picture quality of high-definition television on the HDD 22 without being influenced by other network environments, network usage or the like.

The second LAN terminal 20 is used as a general LAN-compatible port using the Ethernet (registered trademark), and is used to connect a LAN-compatible HDD 24, a personal computer (PC) 25, a digital versatile disk (DVD) recorder 26 with a built-in HDD having a digital broadcast receiving function, and the like, for example, via a hub 23 in order to transmit information to and receive information from these devices.

Note that regarding the DVD recorder 26, since digital information to be communicated via the second LAN terminal 20 is information of a control system alone, a dedicated analog channel 27 needs to be provided in order to transmit analog video and audio information between the digital television broadcast receiving device 11 and the DVD recorder 26.

Further, the second LAN terminal 20 can be connected to a network 29, such as the Internet, via a broadband router 28 connected to the hub 23, and is used for transmission of information, via the network 29, to a remote PC 30, a server 31 of an information provider that performs a content providing service, such as a VOD service, and the like.

The aforementioned USB terminal 21 is used as a general USB-compatible port, and is used to connect USB devices such as a cellular phone 33, a digital camera 34, a card reader/writer 35 for a memory card (not shown), an HDD 36 and a keyboard 37, via a hub 32, for example for transmission of information to these devices.

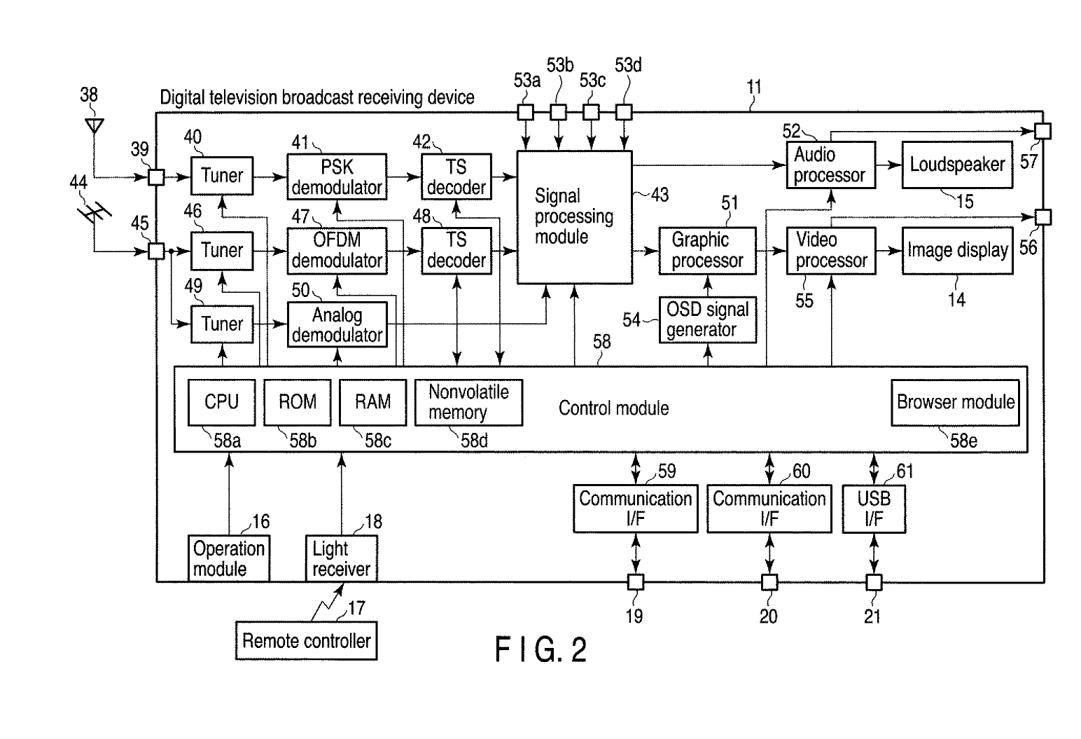

FIG. 2 shows the main signal processing system of the foregoing digital television broadcast receiving device 11. Specifically, a satellite digital broadcast signal received by a BS/CS digital broadcast receiving antenna 38 is supplied via an input terminal 39 to a tuner 40 for satellite digital broadcasting, so that a broadcast signal of a desired channel is selected.

The broadcast signal selected by the tuner 40 is supplied to a phase shift keying (PSK) demodulator 41, where the broadcast signal is demodulated into a transport stream (TS). The TS is supplied to a TS decoder 42 to be decoded into a digital video signal and a digital audio signal, and then the resultant signals are output to a signal processing module 43.

A terrestrial digital television broadcast signal received by a terrestrial broadcast receiving antenna 44 is supplied via an input terminal 45 to a tuner 46 for terrestrial digital broadcasting, so that a broadcast signal of a desired channel is selected.

The broadcast signal selected by the tuner 46 is supplied to an orthogonal frequency division multiplexing (OFDM) demodulator 47, where the broadcast signal is demodulated into a TS. The TS is supplied to a TS decoder 48 to be decoded into a digital video signal and a digital audio signal, and then the resultant signals are output to the signal processing module 43 mentioned above.

A terrestrial analog television broadcast signal received by the terrestrial broadcast receiving antenna 44 mentioned above is supplied via the input terminal 45 to a tuner 49 for terrestrial analog broadcasting, so that a broadcast signal of a desired channel is selected. The broadcast signal selected by the tuner 49 is supplied to an analog demodulator 50, where the broadcast signal is demodulated into an analog video signal and an analog audio signal, and then the resultant signals are output to the signal processing module 43 mentioned above.

Here, the foregoing signal processing module 43 selectively applies given digital signal processing to a digital video signal and a digital audio signal that are supplied from each of the TS decoders 42 and 48, and outputs the signals to a graphic processor 51 and an audio processor 52.

A plurality of (four in the shown case) input terminals 53a, 53b, 53c and 53d are connected to the foregoing signal processing module 43. The input terminals 53a to 53d each allow an analog video signal and an analog audio signal to be input from the outside of the digital television broadcast receiving device 11.

The signal processing module 43 selectively digitizes an analog video signal and an analog audio signal supplied from each of the analog demodulator 50 mentioned above and the input terminals 53a to 53d, and applies given digital signal processing to the digitized video and audio signals, and then outputs the signals to the graphic processor 51 and the audio processor 52.

Among them, the graphic processor 51 has a function of outputting a digital video signal supplied from the signal processing module 43 together with an on screen display (OSD) signal generated in an OSD signal generator 54 superimposed thereon. The graphic processor 51 can selectively output an output video signal from the signal processing module 43 and an output OSD signal from the OSD signal generator 54, and can output both the output signals in such a combination that each of them constitutes a half of a screen.

The digital video signal output from the graphic processor 51 is supplied to a video processor 55. The video processor 55 converts the input digital video signal into an analog video signal in a format that can be displayed on the aforementioned image display 14, and then outputs the video signal to the image display 14 to cause a video display and also leads the video signal to the outside via an output terminal 56.

The foregoing audio processor 52 converts the input digital audio signal into an analog audio signal in a format that can be reproduced by the aforementioned loudspeakers 15, and then outputs the audio signal to the loudspeakers 15 to cause audio reproduction and also leads the audio signal to the outside via an output terminal 57.

Here, in the digital television broadcast receiving device 11, all the operation including the foregoing various receiving operation is controlled as a whole by a control module 58. The control module 58 has a central processing unit (CPU) 58a built therein. The control module 58 receives operation information from the aforementioned operation module 16 or receives operation information that is transmitted from the remote controller 17 and is received by the light receiver 18, and controls each module so that the operation in the operation information is reflected.

In this case, the control module 58 mainly utilizes a read only memory (ROM) 58b in which a control program to be executed by the CPU 58a is stored, a random access memory (RAM) 58c that provides a working area to the CPU 58a, and a nonvolatile memory 58d in which various setting information, control information and the like are stored.

The foregoing control module 58 is connected via a communication interface (I/F) 59 to the first LAN terminal 19. This allows the control module 58 to transmit information to and receive information from the LAN-compatible HDD 22 connected to the first LAN terminal 19 via the communication I/F 59. In this case, the control module 58 has a dynamic host configuration protocol (DHCP) server function, and assigns an internet protocol (IP) address to the LAN-compatible HDD 22 connected to the first LAN terminal 19 so as to control the LAN-compatible HDD 22.

Further, the foregoing control module 58 is connected via a communication I/F 60 to the second LAN terminal 20. This allows the control module 58 to transmit information to and receive information from each device (see FIG. 1) connected to the second LAN terminal 20 via the communication I/F 60.

The foregoing control module 58 is connected via a USE I/F 61 to the aforementioned USB terminal 21. This allows the control module 58 to transmit information to and receive information from each device (see FIG. 1) connected to the USE terminal 21 via the USB I/F 61. In this case, the control module 58 functions to access the specific server 31 by way of the network 29 based on a user's operation, and browse a desired service and acquire a content.

At this point, the foregoing control module 58 functions so as to receive a content transmitted from the server 31, and provide the content for video display on the image display 14 and audio reproduction by the loudspeakers 15 or provide the content for recording, for example, to recoding and reproducing devices such as the HDDs 22, 24 and 36.

That is, the digital television broadcast receiving device 11 has a reproduction function of performing at least one of processing for causing a video display of a content acquired from the server 31 on the image display 14 and processing for causing audio output of a content acquired from the server 31 via the loudspeakers 15.

The foregoing control module 58 is connected via the USB I/F 61 to the USB terminal 21 mentioned above. This allows the control module 58 to transmit information to and receive information from each device (see FIG. 1) connected to the USB terminal 21 via the USB I/F 61.

The foregoing control module 58 comprises a browser module 58e. As described above, the browser module 58e accesses the specific server 31 by way of the network 29, and performs functions of browsing a z service available on the server 31 that is being accessed and acquiring a desired content from the server 31.

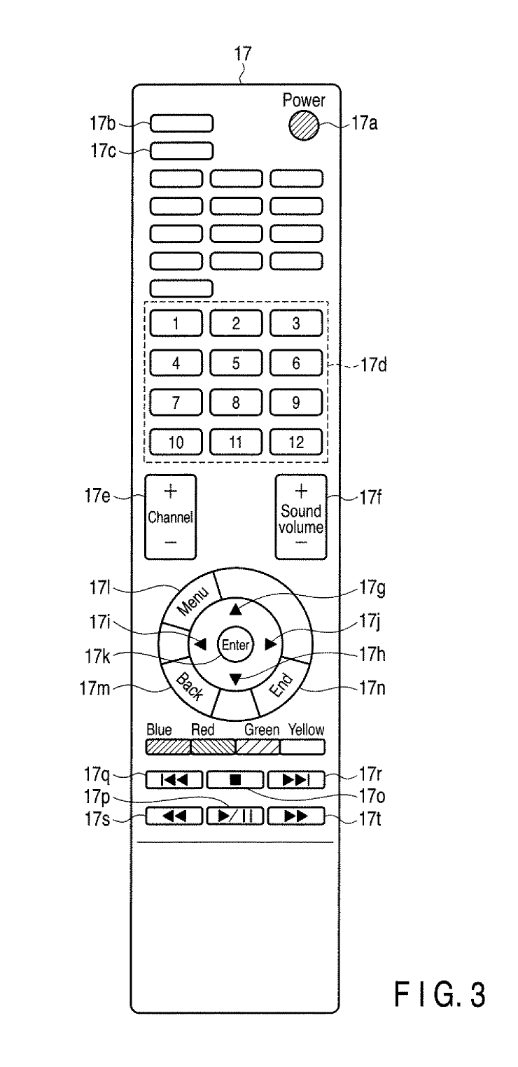

FIG. 3 shows an appearance of the aforementioned remote controller 17. On the remote controller 17, a power key 17a, a first mode switching key 17b, a second mode switching key 17c, channel selection keys 17d, a channel up-down key 17e, a sound volume adjusting key 17f, a cursor up key 17g, a cursor down key 17h, a cursor left key 17i, a cursor right key 17j, an enter key 17k, a menu key 17l, a back key 17m, an end key 17n and the like are mainly provided.

On the remote controller 17, a reproduction stop key 17o, a reproduction/pause key 17p, a backward skip key 17q, a forward skip key 17r, a fast-backward key 17s, a fast-forward key 17t and the like are also provided.

That is, by operating the reproduction stop key 17o and the reproduction/pause key 17p of the remote controller 17, reproduction, stop and pause can be made for contents acquired by a VOD service from the aforementioned server 31.

By operating the backward skip key 17q and the forward skip key 17r of the remote controller 17, a so-called backward skip and a so-called forward skip that skip a content under reproduction by a fixed amount in a backward direction and a forward direction with respect to a direction of reproducing the content can be performed.

Further, by operating the fast-backward key 17s, the fast-forward key 17t and the like of the remote controller 17, a so-called fast-backward reproduction and a so-called fast-forward reproduction that continuously reproduce a content under reproduction at high speed in a backward direction and a forward direction with respect to the reproducing direction of the content can be performed.

Regarding the digital television broadcast receiving device 11 configured as mentioned above, the processing operation for acquiring a desired content from the server 31 and reproducing the content will be described below. In this case, the server 31 distributes a plurality of channels each including a play list of a large number of contents. The server 31 is designed to provide a channel-type VOD service in which when a specific channel is selected by a user and a given content is selected in the selected channel, the selected content is transmitted.

Specifically speaking, the server 31 is designed to provide a broadcasting-like service, in which various contents prepared for a VOD service are classified by type, such as by genre, by title or the like. A plurality of play lists each of which includes the contents classified by type are created such that the contents are arranged along the time base, and each of the plurality of play lists is distributed as a channel so as to be selectable.

Providing such a service allows the server 31 to create and distribute channels that employ only individual contents prepared for a VOD service, such as a movie channel, a sport channel and the like. Therefore, a user can acquire and view a content that suits his or her taste from the server 31 by easy operation that only requires selection of a desired channel. This relieves a user of troublesome searching for a desired content among an enormous amount of contents that the server 31 has.

The contents distributed in such a channel are not contents of conventional broadcasting on the air, that is, contents that are broadcast in one way according to a time schedule on a broadcast station, but, for example, contents prepared for distribution for a VOD service by the server 31.

As such, by operating the remote controller 17, a user can stop and pause reproduction, perform special processing, such as a backward skip and a forward skip, or fast-backward reproduction and fast-forward reproduction mentioned above, for a content under reproduction on a selected channel, and further reproduce contents assigned to past time zones and contents assigned to future time zones.

First, when a user wishes to acquire and reproduce a desired content using a channel-type VOD service from the server 31, the user requests the server 31 to provide a channel-type VOD service by operating the remote controller 17.

More specifically, this request is made as follows. By operating the menu key 171 of the remote controller 17, a user goes through a plurality of menu screens in a hierarchical structure and reaches a menu screen for requesting the server 31 to provide a channel-type VOD service, and the user requests the channel-type VOD service on the menu screen. Upon receiving the request from the user via the remote controller 17, the aforementioned browser module 58e notifies the request to the server 31, which is to provide the service, via the network 29.

Next, upon receiving from the server 31 information (a content) on operation procedures required for receiving the channel-type VOD service, the browser module 58e analyzes this content and performs necessary processing. Here, the content transmitted from the server 31 is, for example, information that is described in hypertext markup language (HTML), and includes video information such as still pictures and programs (software) referred to as “scripts” for various processing.

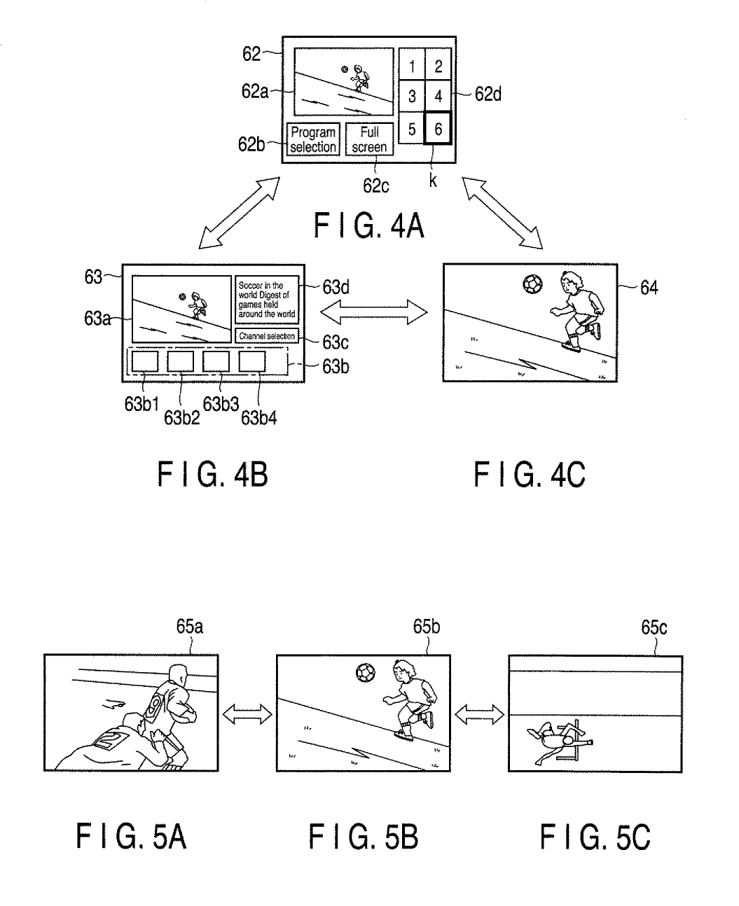

In this case, the browser module 58e generates a channel selection mode screen 62 shown in FIG. 4A based on the content transmitted from the server 31, and causes channel selection mode screen 62 to be displayed on the image display 14. This channel selection mode screen 62 includes a window region 62a that displays a content of a selected channel as a still picture or a moving picture, an operation region 62b for a transition to a program selection mode screen 63 shown in FIG. 4B, an operation region 62c for transition to a full-screen reproduction mode screen 64 shown in FIG. 40, and a channel display region 62d in which a plurality of (six from 1 to 6 in the shown case) channels can be specified. The window region 62a may be configured to allow, for example, video clips of contents distributed on the selected channel to be displayed.

On the channel selection mode screen 62, when a user operates the cursor up, down, left and right keys 17g to 17j or the channel selection keys 17d of the remote controller 17 to position a cursor k in, for example, a region corresponding to the channel 6 in the channel display region 62d, the channel 6 is selected. When the enter key 17k of the remote controller 17 is operated in this state, a picture of a content distributed in the current time zone over the channel 6 is displayed in the window region 62a.

When the enter key 17k is operated with the cursor k positioned in the operation region 62b on the channel selection mode screen 62, the browser module 58e requests the server 31 that a transition to the program selection mode screen 63 be made. In response to the request from the browser module 58e, the server 31 transmits information (content) on operation procedures as described above. In the browser module 58e, the content transmitted from the server 31 is received and analyzed, and the program selection mode screen 63 is displayed on the image display 14.

The program selection mode screen 63 includes a window region 63a in which a picture (still picture or a moving picture) of the currently selected content is displayed, a window region 63b in which a plurality of contents included in the selected channel are displayed in the form of still pictures, an operation region 63c for a transition to the channel selection mode screen 62, and a window region 63d in which information on the currently selected content is presented.

In the window region 63b among the regions, a plurality of (four in the shown case) display regions 63b1 to 63b4 are arranged horizontally. For example, in the display region 63b2, a still picture of a content currently transmitted on the time base is displayed. In the display region 63b1, a still picture of a content before the currently transmitted content on the time base, that is, a content existing in the past direction is displayed.

Further, in the display region 63b3, a still picture of a content after the content currently transmitted on the time base, that is, a content existing in the future direction is displayed. In the display region 63b4, a still picture of a content transmitted after the next to the currently transmitted content on the time base is displayed. That is, in the display regions 63b1 to 63b4 in the window region 63b, a content being later on the time base, that is, a content existing farther in the future direction is displayed in the right in FIG. 4.

On the program selection mode screen 63, when a user operates the cursor up, down, left and right keys 17g to 17j of the remote controller 17 to position the cursor k in a given one of the display regions 63b1 to 63b4 of the window region 63b, a content displayed in the given region is selected, so that a picture of the content is displayed in the window region 63a. That is, an arbitrary content in the same channel can be selected. When the enter key 17k of the remote controller 17 is operated in this state, the browser module 58e requests the server 31 that a transition to the full-screen reproduction mode screen 64 be made.

Further, if the enter key 17k is operated with the cursor k positioned in the operation region 62c on the channel selection mode screen 62, the browser module 58e also requests the server 31 that a transition to the full-screen reproduction mode screen 64 be made.

In the full-screen reproduction mode screen 64, the browser module 58e acquires a content of the channel selected on the channel selection mode screen 62 or a content selected on the program selection mode screen 63 from the server 31 and analyzes the acquired content, and performs a full-screen reproduction process that displays a picture over the entire video display region of the image display 14.

Here, from the server 31, metadata required for reproducing the content is transmitted. In this metadata, content-related information such as a title, size and the like of the content is included. The browser module 58e analyzes the metadata and extracts information required for reproducing the content, and the full-screen reproduction process is performed.

In the full-screen reproduction mode screen 64, stream data transmitted from the server 31 is decoded by the aforementioned signal processing module 43. That is, the stream data transmitted from the server 31 is data in which an encoded video content and an encoded audio content are multiplexed.

In the image display 14, the video content decoded by the signal processing module 43 is displayed on the entire screen. The decoded audio content is converted into sound, and reproduced and output from the loudspeakers 15.

Note that the full-screen reproduction includes the case where a frame of a given width is displayed on any of the left, right, top and bottom of a screen. That is, a manner in which a content is displayed in substantially the entirety of a screen is included in the entire screen reproduction. By such reproduction processing, a user can view a content included in the selected channel (here, a content being currently transmitted) on the full-screen reproduction mode screen 64.

When the first mode switching key 17b of the remote controller 17 is operated on the full-screen reproduction mode screen 64, the browser module 58e requests the server 31 that a transition to the channel selection mode screen 62 be made, thereby enabling a direct transition from the full-screen reproduction mode screen 64 to the channel selection mode screen 62.

Further, when the second mode switching key 17c of the remote controller 17 is operated on the full-screen reproduction mode screen 64, the browser module 58e requests the server 31 that a transition to the program selection mode screen 63 be made, thereby enabling a direct transition from the full-screen reproduction mode screen 64 to the program selection mode screen 63.

Here, when a user operates the cursor left key 17i of the remote controller 17 during such reproduction of a content on the full-screen reproduction mode screen 64, reproduction can be sequentially switched from a content being currently viewed to a content positioned before the currently viewed content on the time base, that is, a content existing in the past direction among contents in the same channel.

When a user operates the cursor right key 17j of the remote controller 17 during reproduction of a content on the full-screen reproduction mode screen 64, reproduction can be sequentially switched from a content being currently viewed to a content after the currently viewed content on the time base, that is, a content existing in the future direction among contents in the same channel.

That is, when a user operates the cursor left key 17i or the cursor right key 17j of the remote controller 17 on the full-screen reproduction mode screen 64, the browser module 58e functions to switch the reproduction process to that of another content of the same channel, without making a transition to the channel selection mode screen 62, the program selection mode screen 63 or the like.

In this case, when acquiring and analyzing a content transmitted from the server 31, the browser module 58e performs a process of switching a content to be reproduced on the entire screen, using scripts (software for performing designated processing) included in HTML information.

That is, during reproduction of the content 65b as shown in FIG. 53 on the full-screen reproduction mode screen 64, when a user operates the cursor left key 17i of the remote controller 17, the browser module 58e performs a process of switching to a content in the past direction by starting the designated scripts. That is, the browser module 58e requests the server 31 that a content that exists before (in the past direction from) the content currently under reproduction on the time base be reproduced on the full-screen reproduction mode screen 64.

Then, the browser module 58e analyzes a content acquired from the server 31, and performs a full-screen reproduction process. In the full-screen reproduction process, as described above, stream data received from the server 31 is decoded by the signal processing module 43. This results in a transition of reproduction on the entire screen from the content 65b that is being currently reproduced, which is shown in FIG. 5B, to the content 65a transmitted before the content 65b on the time base, as shown in FIG. 5A.

On the other hand, during reproduction of the content 65b as shown in FIG. 5B on the full-screen reproduction mode screen 64, when the cursor right key 17j of the remote controller 17 is operated, the browser module 58e performs a process of switching to a content in the future direction by starting the designated scripts. That is, the browser module 58e requests the server 31 that a content that exists after (in the future direction from) the content currently under reproduction on the time base be reproduced on the full-screen reproduction mode screen 64.

Then, the browser module 58e analyzes a content acquired from the server 31, and performs the full-screen reproduction process. This results in a transition of reproduction on the entire screen from the content 65b currently under reproduction, which is shown in FIG. 5B, to the content 65c transmitted after the content 65b on the time base, as shown in FIG. 50.

In other words, the browser module 58e functions even during reproduction of a content on the full-screen reproduction mode screen 64. When operation of switching a content by the use of the remote controller 17, that is, operation with the cursor left key 17i or the cursor right key 17j is performed, a content switching process that makes a transition to another content in the same channel while keeping the full-screen reproduction mode screen 64 is automatically performed.

Therefore, during reproduction of the content selected in the full-screen reproduction mode, seamless switching to a content in the past direction or the future direction can be made on the full-screen reproduction mode screen 64 that is kept without once returning to the channel selection mode screen 62 or the program selection mode screen 63. This enables a user to achieve a seamless content switch with the full-screen reproduction mode screen 64 being kept only by performing easy operation, without performing troublesome operation such as switching of the mode screen.

In the foregoing channel-type VOD service, the number of contents that a server can distribute in one channel, that is, the number of contents contained in a play list provided over one channel is finite. That is, in the case of a channel-type VOD service in which a plurality of contents are distributed along the time base in the same channel, there is a limit in contents that can be selected in the future direction.

That is, there exists a final content on the time base.

Therefore, in this embodiment, during reproduction of a content on the full-screen reproduction mode screen 64, when the last part of the final content on the time base is reproduced, it is shown that reproduction of the final content is completed. Further, after it is shown that the final content is reproduced, another content included in the channel is further reproduced. Specifically, two service configurations, which will be described in the following, are provided.

In a first service configuration, during reproduction of a content on the full-screen reproduction mode screen 64, when the last part of the final content on the time base has been reproduced, the first content (at the beginning) on the time base in the same channel is automatically reproduced from the beginning.

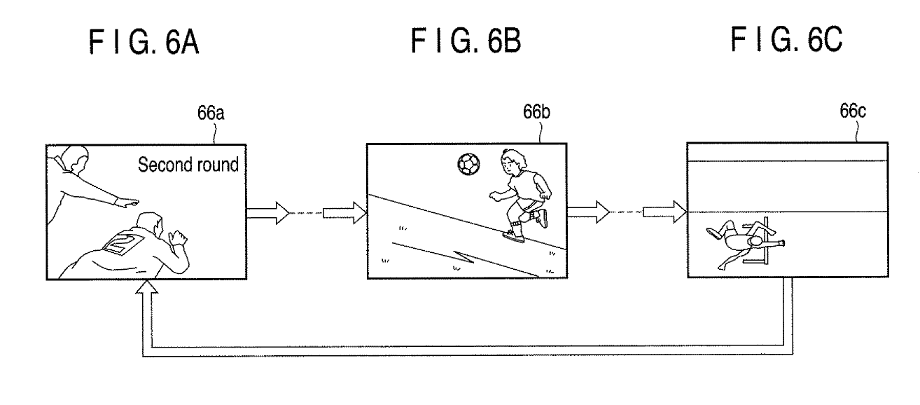

That is, a plurality of contents are distributed along the time base in one channel. In the full-screen reproduction mode screen 64, FIG. 6A shows a first content 66a on the time base, FIG. 6B shows a content 66b currently distributed, and FIG. 6C shows a final content 66c on the time base.

Then, upon completion of reproduction of the last part of the final content 66c on the time base, the browser module 58e functions so that the first content 66a on the time base is automatically reproduced from the beginning.

As such, by automatically starting reproduction of the first content 66a on the time base after reproduction of the content 66c is completed, a user can easily recognize that the previously reproduced content 66c is the final content on the time base of the currently selected channel. This can provide convenient handling for a user, which is suitable for practical use.

In this case, the browser module 58e performs a process of reproducing the first content 66a on the time base from the beginning, upon completion of reproduction of the last part of the final content 66c on the time base, based on scripts transmitted from the server 31.

Performing reproduction of the first content 66a on the time base after completion of reproduction of the last part of the final content 66c on the time base means that a plurality of contents arranged along the time base form a loop. In such a case, as shown in FIG. 6A, if a display, such as “Second round”, is made such that the display is superimposed on a portion of the displayed content 66a to cause a user to recognize formation of a loop (completion of reproduction of the final content on the time base), this can provide more convenient handling for a user.

Such a process of displaying formation of a loop is performed by the browser module 58e based on the scripts transmitted from the server 31.

While the process of reproducing the first content on the time base after completion of reproduction of the final content on the time base is performed in the foregoing description, it is also possible for a user to select in advance a content that he or she wishes to reproduce, so that a process of reproducing that content is performed. In other words, after reproduction of the final content is completed, it is possible to selectively reproduce another content (this content may be the final content) included in the channel.

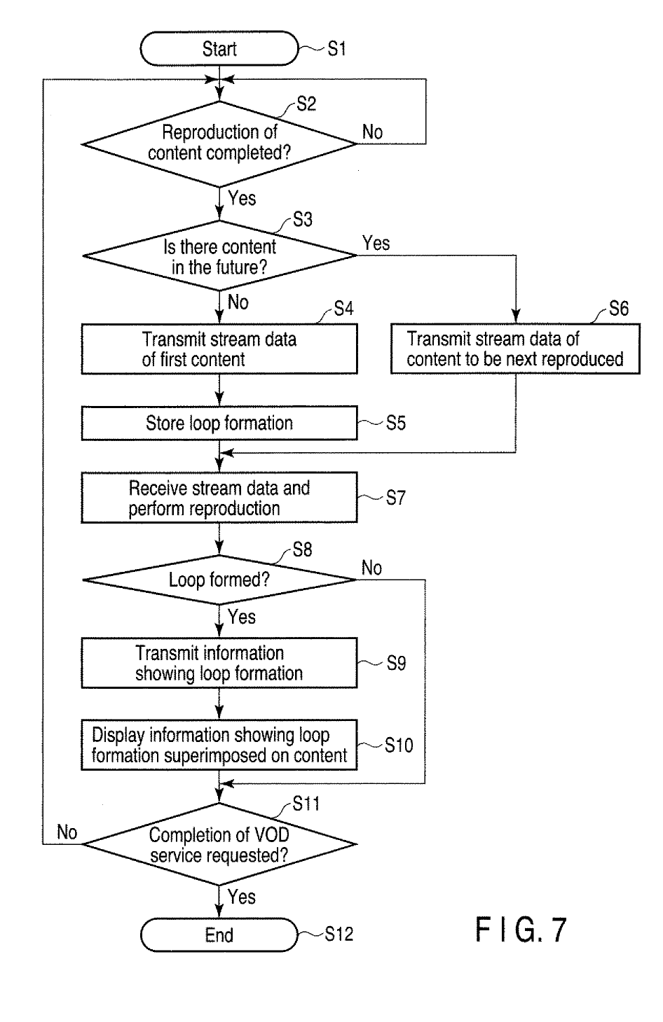

FIG. 7 shows a flow chart that summarizes processing operation of the first service configuration mentioned above. This process starts (step S1) in a state that reproduction of an arbitrary content distributed over a specific channel in the channel-type VOD service is performed on the full-screen reproduction mode screen 64.

Then, the server 31 determines in step S2 whether or not reproduction of a content under reproduction has been completed. If it is determined that the reproduction has been completed (YES), then the server 31 determines in step S3 whether or not there is a content that is scheduled to be distributed in the future from the content under reproduction on the time base.

If it is determined that there is no content that is scheduled to be distributed in the future (NO), then the server 31 transmits stream data of the first content on the time base in step S4, and stores formation of a loop of contents in step S5.

On the other hand, if it is determined in the foregoing step S3 that there is a content that is scheduled to be distributed in the future (YES), then the server 31 transmits stream data of a content to be next reproduced, in step S6.

After the foregoing step 55 or step 56, the browser module 58e receives the stream data of the content transmitted from the server 31 and reproduces the content on the full-screen reproduction mode screen 64 in step S7.

Next, the server 31 determines, in step S8, whether or not a loop of contents has been formed. If it is determined that the loop has been formed (YES), then in step S9 the server 31 transmits information for displaying that a loop has been formed, that is, information for a display saying “second round” in FIG. 6A.

Then, in step S10, the browser module 58e displays the information for displaying that a loop has been formed, which is transmitted from the server 31, such that the information is superimposed on the first content on the time base that is being reproduced on the full-screen reproduction mode screen 64.

Thereafter, the server 31 determines, in step S11, whether or not completion of the VOD service is requested. If the completion is determined to be not requested (NO), then the process returns to step S2, whereas if the completion is determined to be requested (YES), then the process ends (step S12).

The processing operation described in the flow chart shown in FIG. 7 is basically performed by the browser module 58e based on the scripts transmitted from the server 31. However, for example, if information showing that the last part of the final content on the time base has been reproduced is included in metadata transmitted from the server 31, the browser module 58e can be configured to detect that the last part of the final content on the time base based on the information, and automatically perform reproduction of the first content on the time base.

Further, simultaneously, the browser module 58e can be configured to generate information showing a loop has been formed, based on the result of detecting that the last part of the final content on the time base has been reproduced, and to display the information so as to be superimposed on a portion of the first content on the time base.

Next, a second service configuration will be described. In the second service configuration, during reproduction of the content on the full-screen reproduction mode screen 64, when the last part of the final content on the time base is reproduced, absence of a content distributed after the final content and a time required until the next new content is distributed are displayed to a user.

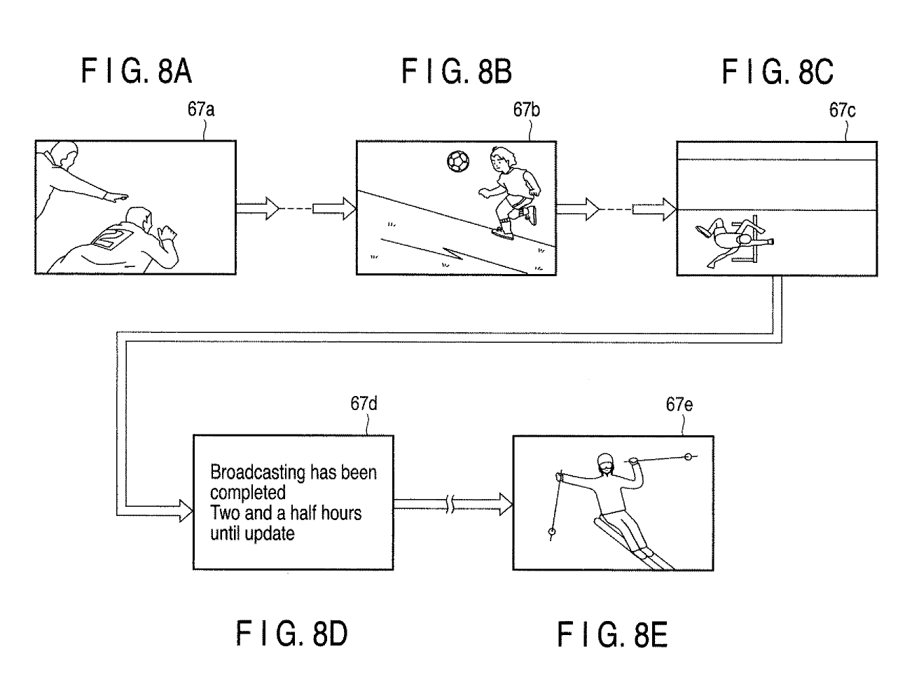

That is, a plurality of contents are distributed along the time base in one channel. In the full-screen reproduction mode screen 64, assume that FIG. 8A shows a first content 67a on the time base, FIG. 8B shows a content 67b being currently distributed, and FIG. 8C shows a final content 67c on the time base.

Then, upon completion of reproduction of the last part of the final content 67c on the time base, the browser module 58e functions so that a broadcast completion screen 67d that includes a message saying “Broadcasting has been completed” that shows absence of a content distributed after the content 67c and a message of “Two and a half hours until update” that shows a time required for update to the next contents is automatically displayed as shown in FIG. 8D.

As such, by automatically displaying the messages by the use of the broadcast completion screen 67d after reproduction of the content 67c has been completed, a user can easily recognize that the previously reproduced content 67c is the final content on the time base of the currently selected channel. This can provide convenient handling for a user, which is suitable for practical use.

In this case, the browser module 58e performs a process of reproducing the messages upon completion of reproduction of the last part of the final content 67c on the time base, based on the scripts transmitted from the server 31.

When contents are updated, reproduction is performed on the full-screen reproduction mode screen 64 from the first content 67e on the time base among a plurality of contents after update, as shown in FIG. 8E.

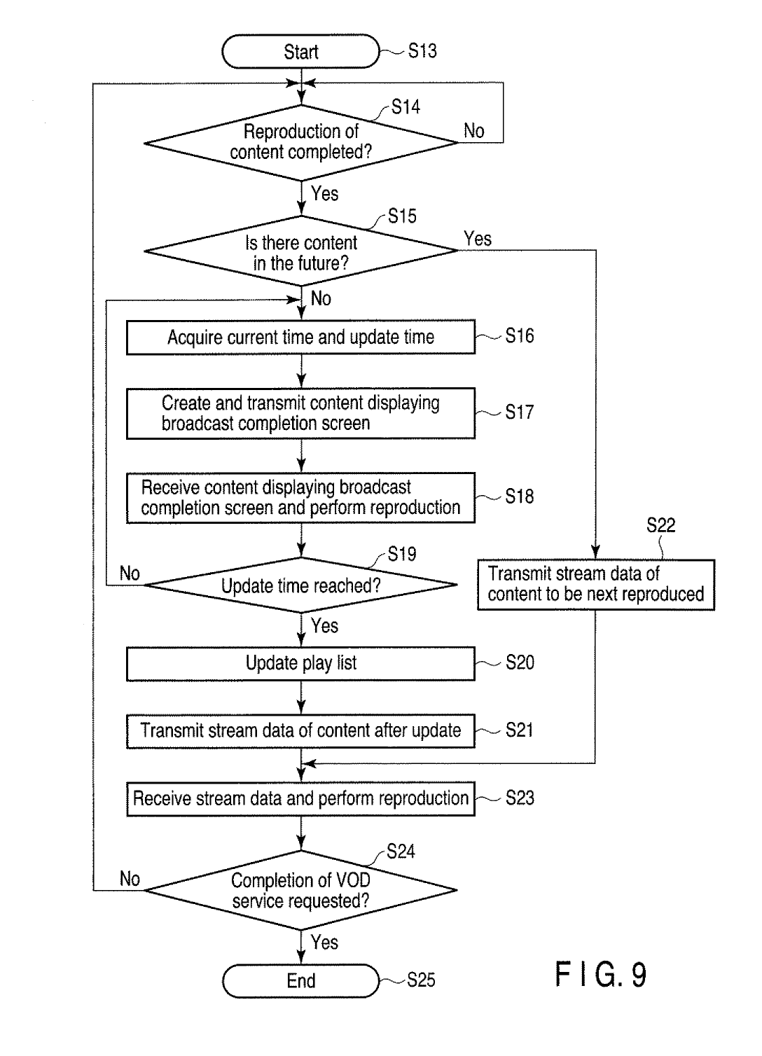

FIG. 9 shows a flow chart that summarizes processing operation of the second service configuration mentioned above. This process starts (step S13) in a state that reproduction of an arbitrary content distributed over a specific channel in the channel-type VOD service is performed on the full-screen reproduction mode screen 64.

Then, the server 31 determines in step S14 whether or not reproduction of a content under reproduction has been completed. If it is determined that reproduction has been completed (YES), then the server 31 determines in step S15 whether or not there is a content that is scheduled to be distributed in the future from the content under reproduction on the time base.

If it is determined that there is no content that is scheduled to be distributed in the future (NO), then in step S16 the server 31 acquires the current time and the time at which contents are next updated, and calculates a time required until update from a difference between the current time and the update time. Then, in step S17, the server 31 creates stream data of a content for displaying the broadcast completion screen 67d including the foregoing messages and transmits the stream data.

Then, in step S18, the browser module 58e receives the stream data of the content for displaying the broadcast completion screen 67d, which is transmitted from the server 31, and reproduces the content on the full-screen reproduction mode screen 64.

Thereafter, the server 31 determines in step S19 whether or not update time for the next contents is reached. If it is determined that the update time is not reached (NO), then the process returns to step 516.

On the other hand, if it is determined that the update time is reached (YES), then in step S21 the server 31 updates a play list in step S20, and transmits stream data of a content after update that is to be currently distributed.

On the other hand, if it is determined in the foregoing step S15 that there is a content that is scheduled to be distributed in the future from the content under reproduction on the time base (YES), then in step S22 the server 31 transmits stream data of a content to be next reproduced.

After the foregoing step S21 or step 522, the browser module 58e receives the stream data of the content transmitted from the server 31 and reproduces the content on the full-screen reproduction mode screen 64, in step S23.

Thereafter, the server 31 determines, in step S24, whether or not completion of the VOD service is requested. If the completion is determined to be not requested (NO), then the process returns to step S14, whereas if the completion is determined to be requested (YES), then the process ends (step S25).

The processing operation described in the flow chart shown in FIG. 9 is also basically performed by the browser module 58e based on the scripts transmitted from the server 31. However, for example, if metadata transmitted from the server 31 includes information showing that the last part of the final content on the time base has been reproduced, update time and other information, the browser module 58e can be configured to detect that the last part of the final content on the time base based on the information to automatically create messages and display the broadcast completion screen 67d.

Here, while this invention has been described taking the digital television broadcast receiving device 11 as an example in the foregoing description, this invention is not limited thereto. For example, this invention can be broadly applied to set top boxes (STB), PCs, cellular phones and so on.

Moreover, by searching for contents that satisfy search conditions set by a user among contents that can be distributed by the server 31 and contents recorded in recording and reproducing devices such as the HDDs 22, 24 and 36, listing the found contents, and associating the contents with a free channel that is not used for television broadcasting, a desired channel can be created. Note that a plurality of desired channels can be created by changing search conditions. This invention can be broadly applied to desired channels created in such a way.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content reproduction apparatus comprising:
a receiving module configured to communicate with a server via a network and receive from the server a channel including a plurality of contents arranged to be distributable along a time base;
a reproduction module configured to selectively reproduce the contents included in the channel received by the receiving module; and
a control module configured to show, as reproduction of a final content on the time base in the channel is completed by the reproduction module, that reproduction of the final content is completed,
wherein the reproduction module is configured to further reproduce another content included in the channel after it is shown that reproduction of the final content is completed.

2. The content reproduction apparatus of claim 1, wherein the control module is configured to detect that reproduction of the final content on the time base in the channel is completed by the reproduction module, and show that reproduction of the final content is completed.

3. The content reproduction apparatus of claim 1, wherein the reproduction module is configured to start reproduction of a first content on the time base of the channel after it is shown that reproduction of the final content on the time base in the channel is completed.

4. The content reproduction apparatus of claim 3, wherein the control module is configured to show that a loop is formed from reproduction of the final content on the time base in the channel to reproduction of the first content on the time base in the channel.

5. The content reproduction apparatus of claim 1, wherein the reproduction module is configured to reproduce a completion screen showing a message saying that reproduction of the final content on the time base in the channel is completed after it is shown that reproduction of the final content on the time base in the channel is completed.

6. The content reproduction apparatus of claim 5, wherein the control module is configured to show a time until the contents included in the channel are next updated.

7. The content reproduction apparatus of claim 1, wherein the reproduction module is configured to selectively reproduce the contents included in the channel by switching the contents to either of a past direction and a future direction on the time base.

8. A content reproduction apparatus comprising:
a communication module configured to be connected with a server via a network; and
a browser module configured to request, via the communication module, the server to acquire a content, and reproduce the content acquired from the server,
wherein the browser module comprises:
a processing module configured to request the server to acquire a channel including a plurality of contents arranged to be distributable along a time base, and receive the requested channel from the server;
a processing module configured to request the server to acquire a content selected based on external operation among the plurality of contents included in the received channel, and acquire the requested content from the server and reproduce the content; and
a processing module configured to receive information showing that reproduction of a final content on the time base in the channel is completed, and show that reproduction of the final content on the time base in the channel is completed, and
the browser module is configured to further reproduce another content included in the channel after it is shown that reproduction of the final content is completed.

9. A method of reproducing a content, comprising:
communicating with a server via a network and receiving from the server a channel including a plurality of contents arranged to be distributable along a time base;
selectively reproducing the contents included in the received channel;
showing, as reproduction of a final content on the time base in the channel is completed, that reproduction of the final content is completed; and
after it is shown that reproduction of the final content on the time base is completed, further reproducing another content included in the channel.
